(19) United States
(12) Patent Application Publication
(10) Pub. No.: US 2021/0095234 A1
(43) Pub. Date: Apr. 1, 2021

(54) TANNIN-BASED CLOUDING AGENTS

(71) Applicant: Kerry Luxembourg S.à.r.l., Luxembourg (LU)

(72) Inventors: Shekhar Umakantrao KADAM, Kildare (IE); Jonathan Doyle, Kildare (IE); Eoin Lalor, Kildare (IE)

(73) Assignee: Kerry Luxembourg S.à.r.l., Luxembourg (LU)

(21) Appl. No.: 16/665,666

(22) Filed: Oct. 28, 2019

Related U.S. Application Data
(60) Provisional application No. 62/907,966, filed on Sep. 30, 2019.

(51) Int. Cl. C12C 5/02

(52) U.S. Cl. CPC C12C 5/02

(57) ABSTRACT

Tannin-based clouding agents are described that when combined with a beverage, such as beer, provide to the beverage a high haze value that is stable over prolonged storage, as well as other benefits. The tannin-based clouding agents include a tannin, such as a plant-derived hydrolysable tannic acid, and can also include a hydrocolloid and/or a yeast extract. Beverages containing the disclosed tannin-based clouding agents are also described. Methods of making and using the disclosed tannin-based clouding agents and beverages containing the disclosed tannin-based clouding agents are also described.

### CROSS REFERENCE TO RELATED APPLICATIONS

This patent application claims the benefit of U.S. Provisional Patent Application No. 62/907,966, filed Sep. 30, 2019, the entire teachings and disclosure of which are incorporated herein by reference thereto.

### BACKGROUND

This section describes the problems as determined by the inventors with respect to imparting and stabilizing a cloudy/hazy appearance in a beverage, which in certain embodiments is beer. Embodiments of the disclosure relate to tannin-based clouding agents that the inventors have found unexpectedly address these problems.

Haze or turbidity in beverages occurs when light passing through a sample is deflected or scattered by suspended particulate matter. An observer perceives the scattered light, causing the sample to appear turbid. As depicted in FIG. 1, this hazy/cloudy appearance in beer results from interactions between proteins, polyphenols and other macromolecules (e.g., oligosaccharides, such as α- and β-glucans) present in the beer.

While beers are often clear in appearance, in certain beers, such as white, wheat, Weiss beers, a key characteristic of the product is its hazy/cloudy appearance. The protein component for forming this hazy/cloudy appearance in beer typically comes from brewers grains, but in some cases proteins from yeast, particularly mannoprotein, are also a source. The interaction of these protein macromolecules with polyphenols present in beer can lead to the formation of larger complexes that give a haze or cloud effect (Steiner, E., Becker, T., & Gastl, M. (2010). Turbidity and haze formation in beer—Insights and overview. Journal of the Institute of Brewing, 116(4), 360-368, incorporated fully herein by reference). The chemical nature and size of these protein-polyphenol complexes impacts the intensity and stability (i.e., time to settling) of the cloud.

Currently, there are very few options for producing beers having a cloudy/hazy appearance, and the options that exist have drawbacks that limit their utility and fail to meet the consumer demand for high-quality and highly consistent beer. While certain beers naturally contain tannins, the inventors have unexpectedly determined that such tannins fail to generate an adequate, uniform, and stable cloudy/hazy appearance due to their chemical and physical properties, such as molecular weight, purity, number of hydroxyl groups and haze-active polyphenolic content.

A cloudy/hazy appearance in beer can result from the brewing process, due to interactions between wheat proteins and polyphenols present in the beer, or where the brewer retains some of the yeast and/or yeast fragments in the final beer without performing a final beer polishing/filtration step. However, these processes are difficult to control, can be quite expensive from a production perspective, and do not allow for the rapid development of new cloud stable products, which is a key feature of today's rapidly evolving beer sector. Furthermore, such processes can lead to an undesirable yeast note in beer, and if the yeast remain active, this can result in further in-bottle conditioning with a detrimental change in the desired flavor and alcohol content of the beer.

Alternatively, clouding agents based on yeast extracts, yeast protein extracts (e.g., U.S. Pat. App. Pub. No. 2019/0161713), and coprah extract have been added directly to beer post-filtration to give a haze/cloud with varying degrees of stability. However, available clouding agents have suffered from a variety of problems, including lower intensity of cloudy appearance, i.e., insufficient haze values; instability of cloudy appearance; undesirable impact on beverage flavor from higher dosage addition of the clouding agent; and high cost-in-use.

The tannin-based clouding agent compositions of the disclosure improve upon the deficiencies described above.

### FIGURES

FIG. 1. Mechanism of haze/cloud formation in beers from protein and polyphenols.

FIG. 2a. Tannic acid sources and dose responses on 90 haze in extra hopped clear lager.

FIG. 2b. Tannic acid sources and dose responses on 25 haze in extra hopped clear lager.

FIG. 3a. Stability study of clouding agents in extra hopped clear lager (90 haze).

FIG. 3b. Stability study of clouding agents in extra hopped clear lager (25 haze).

FIG. 4. Photograph at 14^{th} day of storage of extra hopped lager with added clouding agents.

FIG. 5. Foam enhancement in hazy Indian pale ale after clouding agent application.

FIG. 6. Tribology test after clouding agent application

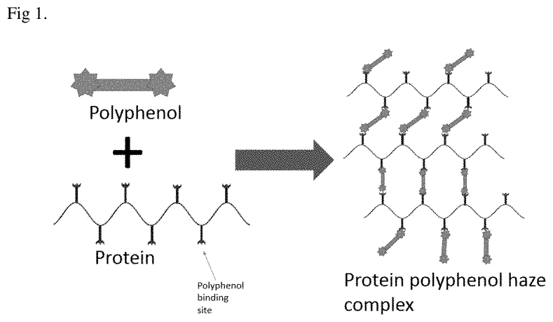

### OVERVIEW

The disclosed tannin-based clouding agents improve upon known clouding agents by providing, when combined with a beverage, such as beer, a higher haze value (more intense cloudy appearance), better cloud/haze stability over prolonged storage, improved mouthfeel (as demonstrated by tribology testing), reduced flavor impact, improved foam stability (NIBEM foam testing), and lower overall production cost of producing cloudy beverages.

In certain embodiments of the disclosure, the tannin-based clouding agents include plant-derived hydrolysable tannic acid in an amount of about 2% to about 100% w/w of the clouding agent. Non-limiting examples of tannins for use in the disclosed clouding agents include gallotannin, catechin, and proanthocyanidin. Exemplary plant sources for obtaining the hydrolysable tannic acid include gallnuts (Rhus semialata and Quercus infectoria), tara pods (Caesalpinia spinosa), Sicilian Sumac leaves (Rhus coriaria), Oak wood (Quercus robur, Quercus petraea and Quercus alba), Chestnut wood (Castanea sativa), Quebracho wood (Schinopsis lorentzii), and turkish gall nuts (Quercus infectoria).

In other embodiments, the tannin-based clouding agents further include a hydrocolloid in an amount up to about 95% w/w of the clouding agent. In certain embodiments, the hydrocolloid can be a water-soluble gum, such as gum arabic, gellan gum, konjac glucomannan, locust bean gum, guar gum, carrageenan, alginate, pectin, and xanthan gum.

In further embodiments, the tannin-based clouding agents include a yeast extract in an amount up to about 95% w/w of the clouding agent. In certain embodiments, the yeast extract is derived from Saccharomyces, Torula, Candida, or Kluyveromyces.

In yet further embodiments, the tannin-based clouding agents include a combination of a hydrocolloid and a yeast extract, each in an amount up to 35-49% w/w of the clouding agent.

Embodiments of the disclosure also include beverages that contain the above-described tannin-based clouding agents, wherein the beverages contain proteins that form complexes with the clouding agent. In certain embodiments the beverage is beer.

In embodiments where the tannin-based clouding agent contains only tannic acid, the clouding agent is present in beer in an amount of about 10 to 100 ppm. In other embodiments where the tannin-based clouding agent contains tannic acid and a hydrocolloid, the clouding agent is present in beer in an amount of about 100 to 1000 ppm. In further embodiments where the tannin-based clouding agent contains tannic acid, yeast extract and a hydrocolloid, the clouding agent is present in beer in an amount of about 100 to 1000 ppm. In yet further embodiments where the tannin-based clouding agent contains tannic acid and a yeast extract, the clouding agent is present in beer in an amount of about 100 to 1000 ppm.

Embodiments of the disclosure include methods for imparting or retaining a clouding appearance to a beverage, including the steps of adding a disclosed tannin-based clouding agent to a beverage, wherein the beverage includes proteins that form complexes with the clouding agent.

### DETAILED DESCRIPTION OF NON-LIMITING EMBODIMENTS OF THE DISCLOSURE

The disclosed clouding agents include tannins that interact with proteins present in beverages to form complexes that confer a stable cloudy appearance or haze, which can be measured by light scattering at 25° and 90° angles. Tannins are polyphenols that include, but are not limited to, tannic acids. In certain embodiments, the disclosed clouding agents include tannic acids.

In beer, this haze-conferring complex is primarily formed by interactions between proline-containing proteins present in the beer and tannins provided by the clouding agent. The clouding agents disclosed herein maintain this tannin-protein complex in suspension within a beverage for a longer duration of time as compared to current technologies. In this respect, the disclosed tannin-protein complexes exhibit a reduced particle size compared to current technologies, increasing sedimentation time and improving haze stability. The clouding agent can be in the form of a dry powder.

In certain embodiments, the clouding agents can include tannic acid alone. In other embodiments, the clouding agents can include tannic acid in combination with one or more hydrocolloids. In other embodiments, the clouding agents include tannic acid in combination with one or more yeast protein extracts. In yet further embodiments, the clouding agents can include a tannic acid, a hydrocolloid, and a yeast protein extract.

Preferably, the tannic acids that are added as a clouding agent are selected based on their ability to generate an adequate cloudy/hazy appearance in a beverage through interactions with proteins contained in the beverage. In certain embodiments, the selection of a tannic acid can be based on chemical and physical properties, such as molecular weight, purity, number of hydroxyl groups and haze-active polyphenolic content. The tannins included in the disclosed clouding agents include plant-derived tannins, such as gallotannin, catechins and proanthocyanidins. In certain embodiments, the selected hydrolysable tannins have high concentrations of hydroxyl groups, which react with nucleophilic SH- and NH-groups of haze-active proteins. In one embodiment, gallotannins extracted from gallnuts are used.

Any plant source of tannins may be used for preparation of the disclosed clouding agents. In non-limiting embodiments of the disclosure, the tannic acid is derived from gallnuts (Rhus semialata and Quercus infectoria), tara pods (Caesalpinia spinosa), Sicilian Sumac leaves (Rhus coriaria), Oak wood (Quercus robur, Quercus petraea and Quercus alba), Chestnut wood (Castanea sativa), or Quebracho wood (Schinopsis lorentzii). In particular embodiments, the tannic acid is derived from turkish gall nuts (Quercus infectoria).

In certain embodiments, clouding agents of the disclosure contain tannic acid in an amount of about 2-100% w/w. In other embodiments, clouding agents of the disclosure contain tannic acid in an amount of 2-30% w/w in combination with other components, such as hydrocolloids and/or yeast extracts. In yet further embodiments, clouding agents of the disclosure contain tannic acid in an amount of 2-10% w/w or even 5-10% w/w in combination with hydrocolloids and/or yeast extracts. The above ranges take into account dosages to confer tannin-protein complexes for production of a haze effect and avoiding impact on taste quality.

Hydrocolloids with emulsion stabilizing capacity, such as water-soluble gums, may be used in combination with tannic acid for preparation of the disclosed clouding agents. Non-limiting water soluble gums for use in the disclosed clouding agents include gum arabic, gellan gum, konjac glucomannan, locust bean gum, guar gum, carrageenan, alginate, pectin, and xanthan.

In embodiments of the tannin-based clouding agents that include a hydrocolloid, the hydrocolloid may be contained in an amount of about up to 95% w/w. In other embodiments, a hydrocolloid is included in an amount of about 60-95% w/w. In other embodiments, a hydrocolloid is included in an amount of about 80-95% w/w. The inventors unexpectedly determined that adding a hydrocolloid in the above ranges provides a synergistic effect, stabilizing tannin-protein complex and improving mouthfeel.

In embodiments of the disclosed clouding agents that include a yeast extract in combination with tannic acid, non-limiting sources of yeast extract include Saccharomyces, Torula, Candida, and Kluyveromyces. Examples of yeast extracts compatible with the disclosed clouding agents include those described in U.S. Pat. App. Pub. No. 2019/0161713, incorporated fully herein by reference.

In embodiments of the tannin-based clouding agents that include yeast extracts, the yeast extract is included in an amount up to about 98% w/w. In other such embodiments, yeast extract is included in an amount of about 60-95% w/w. In other such embodiments, yeast extract is included in an amount of about 80-95% w/w. The above ranges take into account dosages to confer tannin-protein complexes for production of a haze effect and avoiding impact on taste quality.

In embodiments of the tannin-based clouding agents that include a hydrocolloid and a yeast extract, the hydrocolloid and yeast extract each can be included in an amount of about 35-49% w/w of the clouding agent, and the tannin can be included in an amount of about 2-30% w/w of the clouding agent. The above range takes into account dosages to confer tannin-protein complexes for production of a haze effect and avoiding impact on taste quality.

Other food grade ingredients, such as proteins, can be used in combination with the tannins to impart stable cloudy appearance with higher haze value, such as to beer treated with colloidal stabilizers that remove proteins and polyphenols that are present in beer.

Tannic acids can be obtained by conventional methods. For example, tannic acids can be extracted, purified and dried from a plant source according to the method disclosed by Karamac, M., Kosinska, A., Rybarczyk, A., & Amarowicz, R. (2007). Extraction and chromatographic separation of tannin fractions from tannin-rich plant material. Polish Journal of Food and Nutrition Sciences, 57(4), 471-474, incorporated fully herein by reference. Commercially available yeast extracts and hydrocolloids may be used in the disclosed tannin-based clouding agents.

Table 1 describes non-limiting embodiments of tannin-based clouding agent compositions of the disclosure that include tannic acid obtained as described above alone and in combination with commercially available yeast extract and gum acacia. Powder forms of tannic acid, gum acacia and yeast extract were blended together in blender for 30 min to achieve uniform mixing in specific ratio. Three embodiments of the disclosed clouding agents are listed in Table 1 along with their compositions.

TABLE 1
Tannin-based clouding agent compositions

| | % of Tannic | % of | % of Yeast |
|---|---|---|---|
| Embodiment | acid (w/w) | Gum (w/w) | Extract (w/w) |
| TA | 100 | 0 | 0 |
| TA + GA | 2-30 | 70-98 | 0 |
| TA + YE | 2-30 | 0 | 70-98 |
| TA + GA + YE | 2-30 | 35-49 | 35-49 |

*TA—tannic acid, GA—gum acacia, YE—yeast extract

Embodiments of the disclosed clouding agents can be added to a variety of beverages that have proteins that form complexes with the disclosed tannin-based clouding agents, so as to impart or stabilize a cloudy appearance to the beverage. These beverages include alcoholic and non-alcoholic beverages. The alcoholic beverages include both fermented and distilled beverages. In certain embodiments, the beverage is beer. In yet further embodiments, the beer is a pale ale, wheat beer, or a craft beer, such as a hazy IPA. In certain embodiments, the beer contains proteins coming from cereal grains, especially proline containing proteins from barley.

The amount of the clouding agent to be added to a beverage will depend on composition, processing conditions and final desired haze value of beverage. For example, in embodiments where tannic acids alone are used as clouding agents added to a beer, the clouding agents can be added in an amount of between about 10 to 100 ppm. In other embodiments that include tannic acid in combination with a water soluble gum, such as gum acacia, or a yeast extract or both in combination, the clouding agents can be added to beer in an amount of about 100 to 1000 ppm.

The disclosed tannin-based clouding agents can be added to a beverage by a variety of methods. For example, the tannin-based clouding agent can be added by first making 1-5% solutions of the clouding agent in water or beer base by uniformly mixing for a duration of time, such as 15-30 min, at a temperature, such as 5-100° C. The resultant clouding agent solution can then be adding to a beverage at an appropriate dosage rate, such as in a bottle containing 300 ml of the beverage. The bottle is then sealed using capper, inverted to achieve uniform mixing and incubated at desired temperature and time.

Compositions of the disclosure achieve a haze value ranging from 50-150 EBC for lager or hopped beers. For craft beers, such as hazy IPAs, haze values range from 100-250 EBC. These values can be maintained for a period of time ranging from 2 weeks to 2 months.

### EXAMPLES

The following examples have been included to illustrate the presently disclosed subject matter. Certain aspects of the following examples are described in terms of techniques and procedures found or contemplated by the present inventors to work well in the practice of the presently disclosed subject matter. These examples illustrate standard practices of the inventors. In light of the present disclosure and the general level of skill in the art, those of skill will appreciate that the following examples are intended to be exemplary only and that numerous changes, modifications, and alterations can be employed without departing from the scope of the presently disclosed subject matter.

Haze value for all examples mentioned below is measured as turbidity according to known methods, such as with the Sigrist laboratory turbidity meter, wherein the values are expressed in EBC (Steiner, E., Becker, T., & Gastl, M. (2010). Turbidity and haze formation in beer—Insights and overview. Journal of the Institute of Brewing, 116(4), 360-368, incorporated fully herein by reference).

### Example 1

### Increased Dose Application of Tannic Acids

Example 1 studies the influence of different sources of tannic acids (TA) and their increasing dosage rate application on haze value of beverages. The beer used is an extra hopped clear lager beer with an alcohol content of 5% by volume.

Different tannic acid extracts (TA1, TA2, TA3 and TA4) were dosed into the extra hopped lager beer using the above method, where 1% solutions of TA were dosed at an appropriate rate in 300 ml to achieve 10, 20, 30, 40, 50 & 60 ppm final concentration of added TA in final beer.

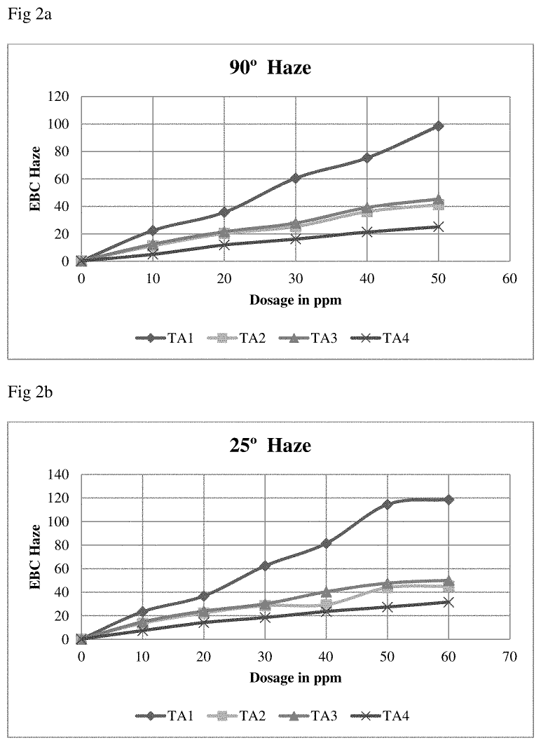

The results are illustrated in FIGS. 2a and 2b. As illustrated, the haze values exhibit a positive correlation with increased dosage application of TA. In particular, TA1 exhibits the highest haze values for both 900 and 250 angle of scatter. There is positive impact of TAs with increased dosage on haze values both at 900 and 250 and in particular, TA1.

### Example 2

### Application Studies of Clouding Agent Formulations in Variety of Beers

In Example 2, three embodiments of tannin-based clouding agents of this disclosure are used to study the hazing effect in a variety of beers. The beers used for this study are listed in Table 2.

TABLE 2
Description of beers

| Beer code | Description |
|---|---|
| A | extra hopped clear lager |
| B | high adjunct lager |
| C | hazy Indian pale ale |
| D | stabilized beer with PVPP and tannic acids |

Three formulations were dosed similarly to Example 1. TA powder on its own was dosed at 50 ppm, whereas TA+GA, TA+YE and TA+GA+YE were dosed at 500 ppm each into all four beers. The study includes a control group of the specified beer without addition of a clouding agent.

Results of this study are shown in Table 3a and 3b. Different beers have shown different haze values at 900 and 25°. Beer C exhibits the highest haze value followed by A, B and D. Higher haze values can be explained by additional phenolic compounds from added hops, contributing to TA-proteins complexes.

Haze values for 900 and 250 have shown higher values with beer with higher polyphenols and proteins. However, beer D exhibits lower haze values, which could be attributed to colloidal stability treatments during production.

TABLE 3a
EBC Haze 90° results of application
of clouding agents in variety of beers

| Beer | TA | TA + GA | TA + YE | TA + GA + YE | Control |
|---|---|---|---|---|---|
| A | 48.8 | 51.2 | 45.9 | 45.2 | 0.129 |
| B | 98.5 | 84.1 | 78.6 | 88.3 | 0.312 |
| C | 188 | 157 | 128 | 167 | 116 |
| D | 13.5 | 12.6 | 11 | 10.4 | 0.287 |

TABLE 3b
EBC Haze 25° results of application
of clouding agents in variety of beers

| Beer | TA | TA + GA | TA + YE | TA + GA + YE | Control |
|---|---|---|---|---|---|
| A | 53.4 | 55.6 | 48.7 | 46.3 | 0.008 |
| B | 114.5 | 105.3 | 84.9 | 79.3 | 0.259 |
| C | 200 | 149 | 136 | 173 | 126 |
| D | 11.1 | 10 | 12.2 | 9.6 | 0.296 |

### Example 3

### Stability Studies of the Clouding Agents

In Example 3, three embodiments were studied for effect of storage on stability of haze values. The beer used for this application is Beer A (extra hopped lager).

Three formulations were dosed similarly to Example 1. TA, GA and YE powder on their own were dosed at 50 ppm, and TA+GA, TA+YE, and TA+GA+YE were dosed at 500 ppm each into all four beers. Haze values for 90 and 250 were measured for 2 weeks at ambient conditions of storage.

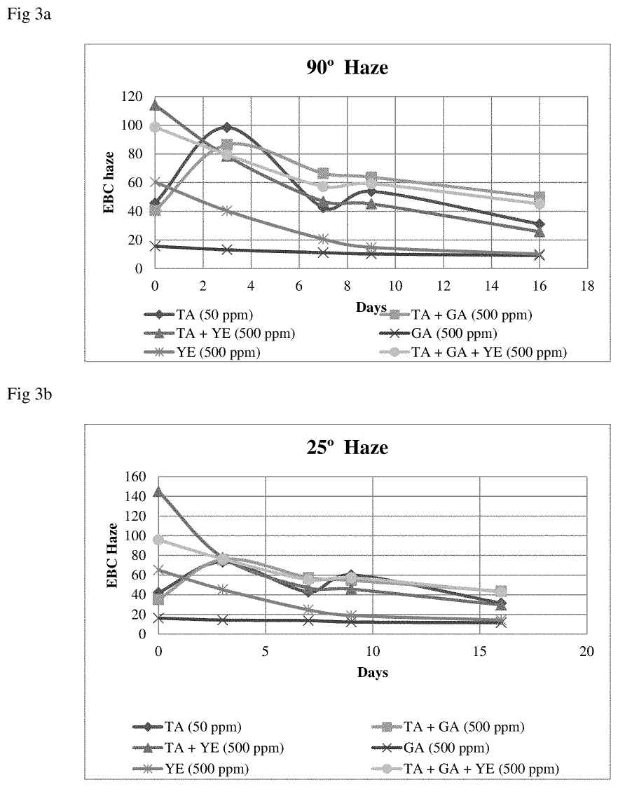

Results of the study are illustrated in FIGS. 3a and 3b. The embodiments containing TA and GA in combination exhibit better cloud stability over a period of time as compared to samples that contain only TA, GA or YE alone. This could be attributed to synergetic effect of stabilization of tannin-protein complex in suspension by GA. Moreover, haze values for embodiments containing TA+YE and TA+GA+YE are much higher by providing additional proteins for formation of tannin-protein complexes.

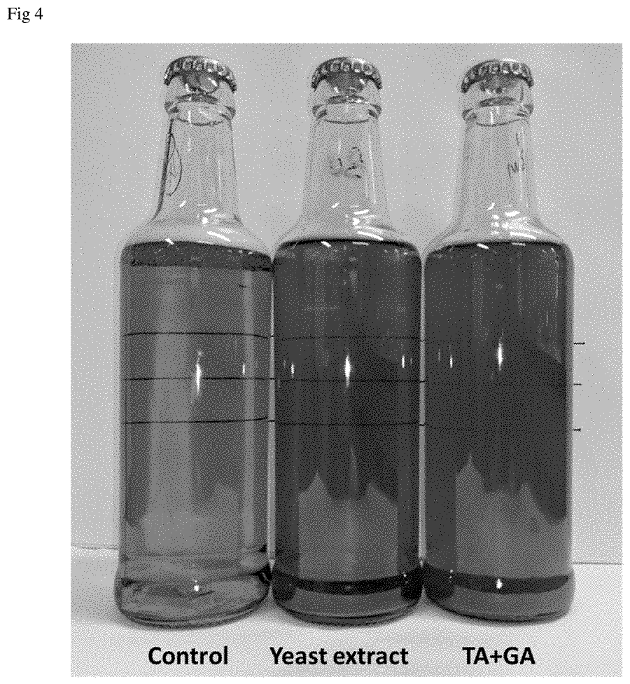

FIG. 4 shows stable cloudy appearance after 14 days of storage in extra hopped lager, comparing beer alone, beer with YE alone, and beer with a combination of TA and GA. FIG. 4 shows the improved cloudy appearance in the embodiment including both TA and GA, compared to the two control samples.

As demonstrated in the above Examples, embodiments containing TA in combination with either GA or YE bring a synergistic effect of stability and higher haze value to beers. Moreover, the use of all three components (TA+GA+YE) when mixed together provide stable haze over period of time.

### Example 4

### Improvement in Foam and Mouthfeel Enhancement

In Example 4, the effects of using tannin-based clouding agents within the scope of the disclosure on foam stability and mouthfeel are studied. The beer used is Beer C (hazy Indian pale ale). Formulations of TA and TA+GA were dosed at rate of 50 and 500 ppm, respectively, according to the method described in Example 1.

Foam measurement was taken using Haffman's NIBEM Foam Stability meter. Foam collapse time over height of 10, 20 and 30 mm was measured and reported according to methods as described in Ferreira et al., 2003, Ferreira, A. A., & Analysis Committee of the European Brewery Convention. (2003). Determination of the Foam Stability of Beer Using the NIBEMQT Meter. Journal of the Institute of Brewing, 109(4), 400-402, incorporated fully herein by reference. For mouthfeel measurement, Anton Parr MCR302 Rheometer was used to draw a Stribeck curve to define sliding velocity (mm/s) and friction factor (μ), according to methods described in Biegler, M., Delius, J., Kasdorf, B. T., Hofmann, T., & Lieleg, O. (2016). Cationic astringents alter the tribological and rheological properties of human saliva and salivary mucin solutions. Biotribology, 6, 12-20, incorporated fully herein by reference.

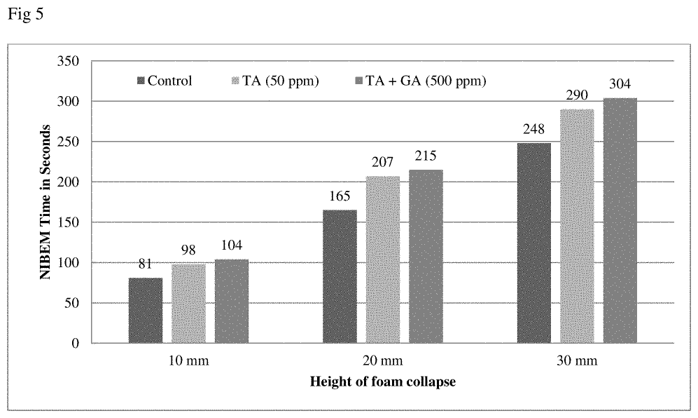

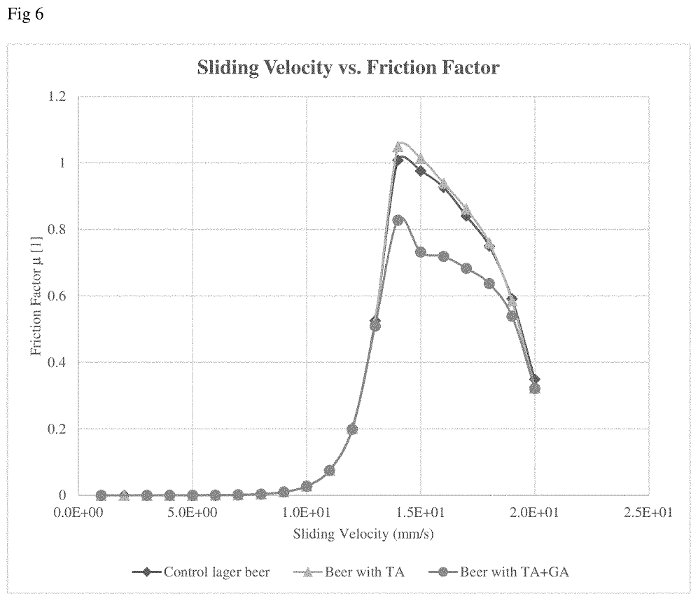

Resulting foam stability and mouthfeel are provided FIGS. 5 and 6. Foam stability exhibits significant improvement on use of both clouding agent embodiments. Additionally, a synergistic effect of TA and GA keeping foam positive components in suspension enhances foam stability. For mouthfeel improvement, use of GA in formulation reduces friction factor and increases lubrication, thus contributing to improved taste quality.

GA used in the formulation of clouding agent in combination with TA brings additional benefits like foam stability and mouthfeel improvement.

What is claimed is:

1. A clouding agent for beverage applications, wherein the clouding agent comprises a tannin in an amount of about 2% to 100% w/w of the clouding agent.

2. The clouding agent of claim 1, wherein the tannin is a hydrolysable tannic acid.

3. The clouding agent of claim 2, wherein the hydrolysable tannin is selected from the group consisting of gallotannin, catechin, proanthocyanidin, and combinations thereof.

4. The clouding agent of claim 2, wherein the hydrolysable tannic acid is derived from a plant selected from the group consisting of gallnuts (Rhus semialata and Quercus infectoria), tara pods (Caesalpinia spinosa), Sicilian Sumac leaves (Rhus coriaria), Oak wood (Quercus robur, Quercus petraea and Quercus alba), Chestnut wood (Castanea sativa), Quebracho wood (Schinopsis lorentzii), turkish gall nuts (Quercus infectoria) and combinations thereof.

5. The clouding agent of claim 1, wherein the clouding agent further comprises a hydrocolloid in an amount up to about 95% w/w of the clouding agent.

6. The clouding agent of claim 5, wherein the hydrocolloid is a water-soluble gum selected from the group consisting of gum arabic, gellan gum, konjac glucomannan, locust bean gum, guar gum, carrageenan, alginate, pectin, xanthan gum, and combinations thereof.

7. The clouding agent of claim 1, wherein the clouding agent further comprises a yeast extract in an amount up to about 95% w/w of the clouding agent.

8. The clouding agent of claim 7, wherein the yeast extract is derived from a yeast selected from the group consisting of Saccharomyces, Torula, Candida, Kluyveromyces, and combinations thereof.

9. The clouding agent of claim 1, wherein the clouding agent further comprises a hydrocolloid and a yeast extract, each in an amount of about 35-49% w/w of the clouding agent.

10. A beverage comprising the clouding agent of claim 1, wherein the beverage comprises proteins that form complexes with the clouding agent.

11. The beverage of claim 10, wherein the beverage is beer.

12. The beverage of claim 11, wherein the clouding agent is contained in the beer in an amount of about 10 to 100 ppm.

13. A beverage comprising the clouding agent of claim 5, wherein the beverage comprises proteins that form complexes with the clouding agent.

14. The beverage of claim 13, wherein the beverage is beer.

15. The beverage of claim 14, wherein the clouding agent is contained in the beer in an amount of about 100 to 1000 ppm.

16. A beverage comprising the clouding agent of claim 7, wherein the beverage comprises proteins that form complexes with the clouding agent.

17. The beverage of claim 16, wherein the beverage is beer.

18. The beverage of claim 17, wherein the clouding agent is contained in the beer in an amount of about 100 to 1000 ppm.

19. A method of imparting or retaining a clouding appearance to a beverage, comprising the steps of adding the clouding agent of claim 1 to a beverage, wherein the beverage comprises proteins that form complexes with the clouding agent.

20. The method of claim 19, wherein the beverage is beer, and the clouding agent is added to the beverage in an amount of about 10 to 100 ppm.

21. A method of imparting or retaining a clouding appearance to a beverage, comprising a step of adding the clouding agent of claim 5 to a beverage, wherein the beverage comprises proteins that form complexes with the clouding agent.

22. The method of claim 21, wherein the beverage is beer, and the clouding agent is added to the beverage in an amount of about 100 to 1000 ppm.

23. A method of imparting or retaining a clouding appearance to a beverage, comprising a step of adding the clouding agent of claim 7 to a beverage, wherein the beverage comprises proteins that form complexes with the clouding agent.

24. The method of claim 23, wherein the beverage is beer, and the clouding agent is added to the beverage in an amount of about 100 to 1000 ppm.

25. A method of imparting or retaining a clouding appearance to a beverage, comprising a step of adding the clouding agent of claim 9 to a beverage, wherein the beverage comprises proteins that form complexes with the clouding agent.

26. The method of claim 25, wherein the beverage is beer, and the clouding agent is added to the beverage in an amount of about 100 to 1000 ppm.

27. A method of making a clouding agent, comprising steps of:
selecting a tannin that is capable of forming complexes with proteins contained in a beverage and thereby impart a hazy appearance to the beverage, and
packaging the tannin as the clouding agent.

28. The method of claim 27, wherein the tannin is a hydrolysable tannic acid.

29. The method of claim 27, wherein the tannin has a molecular weight, hydroxyl group number, or a purity value that enhances the haze-generating effect of the tannic acid.

30. The method of claim 27, wherein the beverage is beer.

31. The method of claim 27, further comprising a step of selecting a hydrocolloid and combining the hydrocolloid with the tannin in a ratio selected to generate a desired hazy appearance in the beverage.

32. The method of claim 27, further comprising a step of selecting a yeast extract and combining the yeast extract with the tannin in a ratio selected to generate a desired hazy appearance in the beverage.

33. The method of claim 27, further comprising a step of selecting a hydrocolloid and a yeast extract and combining the hydrocolloid and the yeast extract with the tannin in a ratio selected to generate a desired hazy appearance in the beverage.
